(19) United States
(12) Patent Application Publication
(10) Pub. No.: US 2025/0042560 A1
(43) Pub. Date: Feb. 6, 2025

(54) HYBRID AIRCRAFT PROPULSION

(71) Applicant: MERIEN BV, Eindhoven (NL)

(72) Inventor: Merien Houten, ten, Eindhoven (NL)

(21) Appl. No.: 18/715,125

(22) PCT Filed: Jan. 14, 2022
(86) PCT No.: PCT/EP2022/050773

§ 371 Date: May 31, 2024

(51) Int. Cl. B64D 27/33; B64C 11/46

(52) U.S. Cl. CPC B64D 27/33; B64C 11/46; B64D 2221/00

(57) ABSTRACT

An aircraft and a hybrid aircraft propulsion system for the aircraft is disclosed. The aircraft has propellers and a jet engine. The propellers convert energy generated by the generator into a mechanical energy for rotating the blades and vice versa. The aircraft preferably has a configuration with left and right wing mounted propellers with electrical engines which may also function as electrical generators, a tail mounted jet engine with a coupled electrical generator, and optionally left and right wing mounted jet engines. The tail mounted jet engine is provided with air for combustion via an air intake of an S-duct type, whereby the rotor of the generator is positioned in line with the turbine shaft, therefore not disturbing airflow. A method is provided to calculate a safe flight of the aircraft, even when exclusively flying on electrical energy.

### TECHNICAL FIELD

The invention relates to aircraft propulsion systems that use power from both an internal combustion engine (jet engine) and electric propulsion, such as a propeller which is powered by an electric engine.

### BACKGROUND

There are many benefits of having a propulsion system in an aircraft without the need for consuming fossil fuel at all. In contrary to internal combustion engines, alternative propulsion systems, such as electric propulsion, do not produce gaseous emission such as NOx or CO2. Currently, there are experiments and success in using electric propulsion systems, whereby electric energy is converted to rotational energy by an electric motor to drive a fan or a propeller which usually comprises blades. The energy is provided by rechargeable batteries.

Besides the emission of exhaust gases, jet engines usually produce a lot of noise, whereas alternative propulsion systems usually create much less noise, at least inside the cabin. Although air traffic industry expresses a need to continuously expand to stay economically viable, public support for increase of air traffic is diminishing, for example because of depletion of fossil fuels, and more importantly, because of the undeniable climate change resulting from fuel combustion and CO2 emissions. Especially with jet fuel powered aircrafts, emission rates are relatively high. Moreover, aircrafts with jet engines produce noise, which leads especially in populated areas, such as cities, to adversary effects of air traffic.

Last but not least, a big disadvantage of using jet engines in aircrafts, lies in the very high costs of production, purchase and maintenance of jet engines. Jet engines are considered to be the most expensive parts of an aircraft with this respect.

The future of traveling by air therefore is to be found in using propulsion systems which are not, or much less dependent on the burning of (fossil) fuels) during flight and keep noise production within acceptable limits. Unfortunately, currently available energy storage systems for alternative propulsion systems still pose problems. For example, in long distance flights, such as transatlantic flights, it would require such a big payload of batteries that a fully electrically propelled aircraft would not even be able to take off because of the extra weight. One way to prevent that an aircraft becomes too heavy is to not completely depend on electric motors, and to combine the propulsion system with internal combustion engines such as jet engines which consume fuel having a much higher energy to weight ratio than batteries. These so called hybrid aircraft propulsion systems which combine jet engines and electric propellers provide a promising solution, but there are still many problems to tackle and challenges to meet to really reduce emissions and noise and still provide a safe flight of an aircraft over a long distance.

Previously disclosed aircraft propulsion systems are published as patents and patent applications, of which the following publications are discussed.

Patent application NL1043733 by applicant is summarized as a hybrid aircraft propulsion system for an aircraft with propellers and a jet engine with a coupled energy generator. The propellers convert energy generated by the generator into a mechanical energy for rotating the blades. The aircraft preferably has a configuration with left and a right wing mounted propellers and a tail mounted jet engine, a tail mounted propeller and left and right wing mounted jet engines or left and right wing mounted jet engines and left and right wing mounted propellers. The jet engine is provided with air for combustion via an air intake of an S-duct type, whereby the rotor of the generator is positioned in line with the turbine shaft, therefore not disturbing airflow.

USA Patent application US 2020/0148372 A1 is summarized as a hybrid aircraft propulsion system with power units to output electrical energy onto electrical busses; propulsors; and electrical machines, each electrical machine driving a propulsor using electrical energy from the electrical busses.

UK Patent application GB 2575743 A is summarized as an aircraft propulsion system in which an engine has an engine core with a compressor, a combustor and a turbine driven by a flow of combustion products of the combustor. A propulsive fan generates a mass flow of air to propel the aircraft. An electrical energy store is provided on board the aircraft. An electric motor is arranged to drive the propulsive fan and the engine core compressor. The electric motor is controlled to selectively drive the propulsive fan and engine core compressor. The electric motor may assist the engine core compressor by supplementing the torque applied from the turbine.

USA Patent application US 2010/0083632 A1 is summarized as a hybrid propulsive technique, providing thrust associated with a flow of a working fluid through a jet engine. Electrical power from the working fluid is converting to torque. An independently rotatable compressor rotor rotates axial flow responsive to converting the electrical power to torque.

USA patent application US 2018/0079516 A1 is summarized as an aircraft with a hybrid power generation system having an engine with a mechanically coupled generator and a propulsion system with an electric motor electrically coupled to the generator and a rotational mechanism coupled to the electric motor.

USA Patent application US 2018/0037333 A1 is summarized as an aircraft where an engine creates mechanical energy. That energy is then converted into electrical energy using a generator and delivered to remotely-located propellers on the aircraft.

European patent application EP 3 556 658 A1 is summarized as a hybrid propulsion engine for aircraft with a propulsor driven by a gas turbine engine in a first mode of operation. An electric motor drives the propulsor during a second mode of operation, whereby a damper in the core air intake of the gas turbine engine blocks the airflow.

USA Patent application 2014/0367510 is summarized as an aircraft with hybrid motorization having electric propulsion arranged on each side of the fuselage. An electrical energy generator, electricity storage and supply devices are arranged along a longitudinal axis of the fuselage.

### DISCLOSURE OF INVENTION

It is an object of the present invention to increase safety for airplanes, by optimizing hybrid propulsion systems, and by providing a safe propulsion system which is suitable for replacing fossil fuel at least partly by electrical energy. It is a further object to reduce fuel consumption and noise in comparison with aircraft of a comparable capacity. It is yet a further object to store energy generated by a jet engine for later use.

Last but not least, it is an object of the invention to reduce costs for production and maintenance of an airplane and its parts.

The object is realized by creating a jet engine generator which provides electricity for electric engines of aircraft propellers and is configured with a system whereby one propulsion system is arranged as a back-up for a second propulsion system and optionally vice versa, and which may optionally provide auxiliary or redundant power.

The invented aircraft may be equipped with less jet engines and/or without separate auxiliary power unit (APU), thereby reducing costs of production and maintenance.

The invented aircraft is provided with energy accumulators, such as batteries which are preferably (also) capable for short term storage and power delivery of electricity to be used when maximum thrust is needed i.e. during take-off.

In summary the invented system is arranged for:
charging the batteries and use the batteries to power the electric driven propellers;
running the propellers directly from power generated by the hybrid jet engine;
minimizing or redirecting thrust from the jet for use in stationary (on the ground) condition.

For each flight, the invented system will calculate a minimum necessary charge level, so the batteries provide enough energy so safely reach the nearest suitable airport, when using only battery power.

The system calculates expected potential full electric flying time based on any one of the following variables:
distance to the nearest suitable airport. These data may be available or made available in the Flight Management System, containing a database of suitable airports;
state of charge (the level of charge of an electric battery relative to its capacity);
state of the batteries (whereby efficiency of the batteries may decrease by aging of the batteries;
calculated electrical energy consumption during take-off and landing;
weather factors, such as temperature humidity, wind force and wind direction;
takeoff weight of the airplane.
   Based on the route this is calculated before the start of the flight, so the system can calculate the minimum state of charge for each point in the flight. Based on this information the system calculates how much the batteries need to be charged at certain points in flight or how much they can be used as an extra source of power.

During the flight, the system continuously updates this information based upon any or preferably all of the above mentioned variables, so changes due to changing weather, deviations etcetera may be taken into account.

A planned route of the airplane may consist of various subsequent paths with different requirements depending on e.g. geographical characteristics, such as over land or over sea, over mountains or over deserts, overcrowded areas or over troubled regions. Each airspace of a country may have a different air traffic regulation. The system or the pilot may take these aspects into account by, for example, engaging electric-only flight in certain paths in the route. Electric-only flightpaths may be particularly useful to fly over, or land or take off, in areas with strict environmental regulations, such as reduction of emissions or noise.

In case of an emergency where the jet engine is unusable. i.e. engine failure, loss of fuel pressure etcetera, the airplane may divert to the nearest suitable airport and safely land, purely on battery power.

In an emergency where both the electric system and the jet engine remain available, i.e. a medical emergency, structural damage not impacting the propulsion systems, the pilot may choose any available suitable airport. This new destination will be entered into the system, which will again calculate the desired state of charge.

In an emergency where the electric system should fail, the plane, as is in current regulations, will have enough fuel to reach a suitable airport and land.

The automated system controlling the balance between charging and trust requires no input from the pilots during the flight. In case of a situation where the state of charge is less than needed to reach a suitable airport, i.e. when there is an unplanned deviation, the system will alert the pilot and start to resolve this situations, by leading more power to the generator for example.

Battery power can be used to supplement the jet when the state of charge is higher than necessary. Before takeoff, preferably the batteries have a maximum state of charge. If necessary, they need to be recharged, by a ground station, or when there is a possibility to charge the batteries by running the jet engine, generating electricity from a generator coupled to the jet engine. Preferably the generator of the jet engine is engaged before the state of charge of the batteries reach a minimum level. Charging the batteries by the jet engine generator, is preferably done during the cruising part of the flight, when the jet engine has ample power.

On board computers will monitor the state of charge and configure jet trust, propellor trust and engagement of the generator in such a way that a safe and fuel efficient flight is provided.

Further embodiments of the invention are summarized in the following clauses and further embodiments.

1. A hybrid aircraft propulsion system comprising:
one or more propellers, arranged as electric propellers comprising rotatable blades and arranged for being powered by a propeller electric motor, whereby the propeller electric motor is arranged for using electric energy from an electric energy supply system for powering the propellor electric motor;
one or more jet engines;
a control unit arranged for controlling the one or more propellers and/or the one or more jet engines;
a jet engine generator associated to a jet engine of the one or more jet engines and arranged for being coupled to the associated jet engine and arranged for converting or transferring energy generated by the jet engine,
an electric jet engine generator arranged for converting energy generated by the jet engine into electric energy, whereby electric energy generated by the electric generator is storing in the electric accumulator, is used for providing electric energy to electric systems of the aircraft and/or used for providing electric energy to the one or more electric propellers.
an energy management system arranged for controlling the acceptance of energy by the energy accumulator, storage of energy in the energy accumulator and release of energy from the energy accumulator.
   characterized in that,
   a propeller of the one or more propellers is arranged for being selectively using electric energy from the electric energy supply system, using electric energy generated by the jet engine generator directly, or being switched to generating electric energy.

2. The system according to clause 1, characterized in that the system is arranged for storing the generated electric energy in an energy accumulator which is arranged for storing, converting and/or releasing energy as needed.

3. The system according to clause 1, characterized in that the electric energy supply system comprises an on-board energy supply system such as:
the jet engine generator;
an electric accumulator type of the energy accumulator, arranged for accepting, storing and releasing electrical energy as needed, the electric accumulator comprising one or more rechargeable batteries and/or capacitors, such as supercapacitors or ultracapacitors, a DC/AC convertor and a charger.
a fuel cell system arranged for converting chemical energy of a fuel, such as hydrogen, and an oxidizing agent into electricity, said fuel cell system arranged for being refueled form an external fuel storage.
a solar energy system arranged for converting light into electricity.

4. The system according to clause 1, characterized in that a further type of the energy accumulator comprises a mechanical accumulator arranged for accumulating potential energy arranged for accumulating non-electric energy generated by the jet engine.

5. The system according to clause 1, characterized in that a further type of the energy accumulator comprises a pneumatic accumulator arranged for accumulating pneumatic energy or a hydraulic accumulator arranged for accumulating hydraulic energy generated by the jet engine.

6. The system according to clause 3, characterized in that the energy supply system comprises an off-board energy supply system, whereby the aircraft is arranged for exchanging energy with said off-board energy supply system.

7. The system according to clause 1, characterized in that the control unit is arranged for optimizing the propulsion ratio between propellers, jet engine generator, and charging of the energy accumulator appropriate for the actual, desired and/or predicted flight situation of the aircraft.

8. The system according to clause 1, characterized in that the control unit is arranged for functioning fully or partly manually, automatic, with artificial intelligence, or any combination.

9. The system according to clause 1, characterized in that the control unit is arranged for executing actions of the group comprising:
switching the one or more jet engines on or off or controlling throttle;
switching the one or more propellers on or off, controlling throttle or changing the blades' pitch;
coupling or decoupling the jet engine generator to and from an associated jet engine;
coupling or decoupling the propeller motor to and from an associated propeller;
switching the jet engine generator from the energy generation mode to the energy consumption mode and vice versa;
switching the propeller motor from the energy consumption mode to the energy generation mode and vice versa.

10. The system according to clause 1, characterized in that the system comprises an electrical configuration whereby a first propeller of the one or more propellers is electrically connected to a first and/or a second jet engine of the one or more jet engines and to a first and/or second energy accumulator, and a second propeller of the one or more propellers is electrically connected to the first and/or the second jet engine and to the first and/or second energy accumulator, whereby the first propeller is arranged for continued operation when the second propeller or when the first or second energy accumulator fails.

11. An aircraft comprising the hybrid aircraft propulsion system of clause 1, the aircraft having a fuselage comprising:
one or more electric propellers, such as open rotors or ducted fans arranged for providing propulsion of the aircraft, a propellor of the one or more propellors comprising rotatable blades, arranged for being powered by a propeller electric motor, whereby the propeller electric motor is arranged for using electric energy from an electric energy supply system;
one or more jet engines, such as gas turbines, a jet engine of the one or more jet engines comprising an intake duct for providing air for combustion of a combustible fuel, a turbine and a central longitudinal turbine shaft substantially oriented in longitudinal direction of the fuselage;
an electric jet engine generator arranged for converting energy generated by the jet engine into electric energy, and storing the electric energy in an electric accumulator, whereby the stored electric energy is used for providing electric energy to electric systems of the aircraft and/or used for providing electric energy to the one or more electric propellers;
a control unit arranged for controlling the one or more propellers and/or the one or more jet engines;
an energy management system arranged for controlling storage of energy in the energy accumulator and release of energy from the energy accumulator.
   characterized in that,
   a propeller of the one or more propellers is arranged for being selectively using electric energy from the electric energy supply system, or using electric energy generated by the jet engine generator directly, or being switched to generating electric energy by converting rotational power of the blades as caused by an air stream into electric energy for providing power to the aircraft and/or for storing in the one or more energy accumulators.

12. The aircraft according to clause 11, characterized in that the jet engine generator is arranged for being selectively coupled to or decoupled from the associated jet engine and, when coupled to the associated jet engine, arranged for converting or transferring energy generated by the jet engine.

13. The aircraft according to clause 11, characterized in that the intake duct is of an S-duct type, whereby the rotor of the jet engine generator is positioned in line with the turbine shaft and substantially in line with the longitude of the fuselage.

14. The aircraft according to clause 13, characterized in that the turbine shaft is further arranged as the rotor of the jet engine generator, and arranged for selectively being coupled to and decoupled from the turbine shaft via a gear mechanism, whereby the jet engine generator is rotatable in opposite direction of the turbine.

15. The aircraft according to clause 11, characterized in that the fuselage comprises a left wing and a right wing, whereby a configuration of the one or more propellers and the one or more jet engines comprising any one of the group comprising:
left and a right wing mounted propellers and a tail mounted jet engine.
a tail mounted propeller and left and right wing mounted jet engines;
left and right wing mounted jet engines and left and right wing mounted propellers.

16. The aircraft according to clause 15, characterized in that the configuration is arranged for providing at least a minimum of required combined propulsion power, whereby a redundant jet engine or propeller is provided as a back-up engine or as a sole or additional power source for generating energy for storing in the one or more energy accumulators.

17. The aircraft according to clause 11, characterized in that the jet engine generator comprises an electric motor-generator arranged for being selectively switched from an energy generating mode for generating electric energy, to an electric energy using mode for converting electric energy into mechanical energy for spinning turbine blades of the coupled jet engine in a cold start.

18. The aircraft according to clause 11, characterized in that two or more propellers of the one or more electric propellers are arranged for being selectively electrically or mechanically coupled and decoupled.

19. The aircraft according to clause 11, characterized in that the jet engine generator comprises a rotor rotatable in a stator, and the jet engine is of a turbine type with a rotatable fan, a compressor fan and a turbine, said turbine arranged for rotating a central turbine shaft, whereby the rotor of the jet engine generator is arranged for being selectively coupled to or decoupled from the turbine shaft.

20. A method for hybrid aircraft propulsion system in accordance with clause 1, the method comprising that before a flight of the aircraft, the control unit of the system calculates a minimum necessary charge level and expected potential full electric flying time, when using exclusively battery power, thereby taking into account any one or any combination of variables of the group comprising:
distance to the nearest suitable airport;
state of charge;
state of the batteries;
calculated electrical energy usage during take-off and landing;
weather factors, such as temperature humidity, wind force and wind direction;
takeoff weight of the airplane.

### BRIEF DESCRIPTION OF THE DRAWINGS

The figures show views of embodiments in accordance with the present invention.

FIG. 1 shows a schematic representation of the invented system.

FIG. 2 shows a front view of an embodiment of the invented system incorporated in an example aircraft with one tail mounted jet engine and two wing mounted propellers.

FIG. 3 shows a side view of the depicted aircraft of FIG. 2.

FIG. 4 shows a section A of FIG. 3, with a see through detail of an s-duct and jet engine.

### DETAILED DESCRIPTION

The invention is now described by the following aspects and embodiments, with reference to the figures.

The invention proposes to generate, use and store energy from different sources (energy supply systems) on board of the aircraft as well as from outside of the aircraft (such as available at an airport). The proposed configurations do not compromise safety of an aircraft and may even enhance safety. In principle at least two technologies for propulsion are applied which operate at least partly independently form each other, and therefor provide a mutual back up system. The used engines are configured to provide a degree of redundancy which adds to the safety of the aircraft.

This way, the implementation of the invented system becomes possible for aircrafts which e.g. should be able to fly transatlantic. Standards, such as ETOPS (acronym for Extended Operations), and in particular ETOPS 180 and beyond can be met because by e.g. the invented there-engine configuration with one tail mounted jet engine and two wing-mounted propellers which secure that the aircraft can safely cross the ocean.

Furthermore, due to low maintenance requirements of electric engines, the proposed configurations potentially lead to lower total maintenance costs than a conventional aircraft with only jet engine topology.

On-board electric energy supply systems comprise for example:
a (hybrid) jet engine electric generator;
an electric accumulator type of the energy accumulator, arranged for accepting, storing and releasing electric energy as needed, the electric accumulator comprising one or more rechargeable batteries and/or capacitors and/or other electric charge storing solution, such as supercapacitors or ultracapacitors;
a fuel cell system arranged for converting chemical energy of a fuel, such as hydrogen, and an oxidizing agent into electricity, said fuel cell system arranged for being refueled form an external fuel storage.
a solar energy system arranged for converting light into electricity.

The proposed control unit, i.e. a computer, is used to control the operation and cooperation of the engines, the charging and discharging of energy accumulators and coupling of various systems and engines. The control unit may in this way optimize the ratio between propellers, generator, propulsion and charging appropriate for the actual, desired or predicted flight situation. Control unit may function fully or partly manually, or automatic e.g. with artificial intelligence, or any combination.

Hereinafter a jet engine electric generator in combination with an electric energy accumulator are further discussed as part of a preferred embodiment.

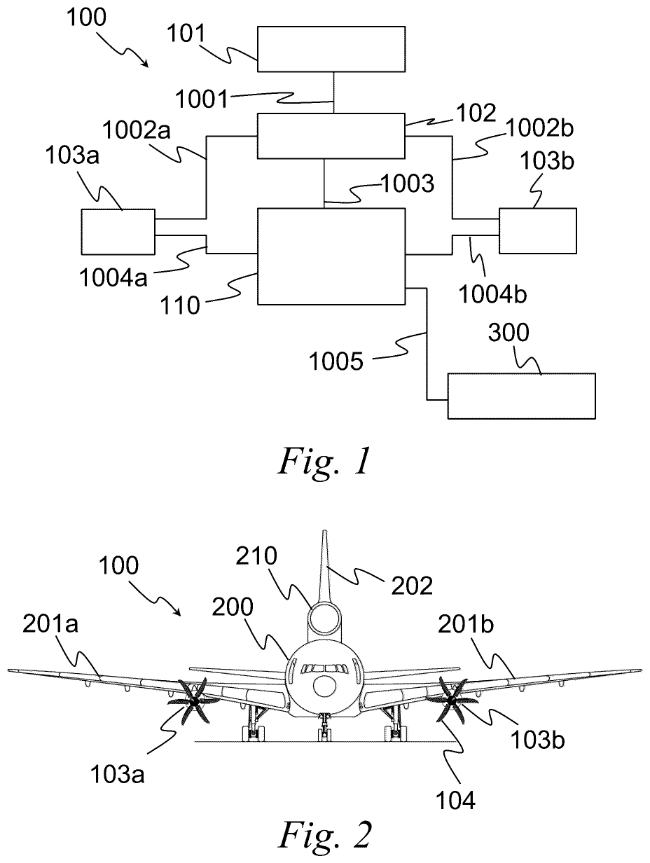

FIG. 1 shows a schematic representation of the invented system 100, wherein the blocks represent various elements such as devices and systems which may make up the system. The lines between the blocks represent electrical or mechanical connections between the elements. For the example in the figure embodiments are described hereafter which are based on electrical connections. Any or all of the connections may be connected or disconnected by a control unit (not shown).

Jet engine 101 is connected at 1001 to jet engine generator (hereinafter also referred to as “generator”) 102. When the jet engine is in operation, typically combustion of a fuel is used to rotate the turbine blades in the jet engine for providing thrust. The rotational mechanical movement is converted into electric energy by generator 102, which is preferably directly coupled to the spinning turbine. Generator 102 preferably comprises a rotor rotatable in a stator, and the jet engine is of a turbine type with a rotatable fan, a compressor fan and a turbine, said turbine rotates a central turbine shaft, whereby the rotor of generator 102 is coupled to the turbine shaft. The central shaft of the turbine may therefore function as or be coupled to the rotor of generator 102 and generator 102 functions as a dynamo in this way.

The electric energy generated by generator 102 may be led via 1002a,b directly to the one or more propellers 103a,b respectively. Propeller 103a may be mounted to the right wing of aircraft 200 as depicted in FIG. 2, whereas propeller 103b may be mounted to the left wing of aircraft 200. Having a propeller on the left and the right side of aircraft 200 provides for stability. Multiple propellers may, however, be mounted left and right or even additionally in a central position such as next or above the tail of aircraft 200.

Additionally, or instead, generator 102 may also direct electric energy via 1003 to energy accumulator 110. Energy accumulator 110 preferably comprises one or more batteries or battery packs. This way, the stored electric energy may be used for providing additional power to propellers 103a,b by directing energy through connections 1004a,b to propellers 103a,b respectively, during take-off for example, when much power is needed from both jet engine 101 and propellers 103a,b to provide thrust. It should be clear of course, that when jet engine 101 converts mechanical power into electric energy, this reduces available power for thrust, therefore the energy accumulator is preferably charged fully by a ground station 300 (via connection 1005, which may be made when stationary, and which is released before the aircraft moves away) and/or when the jet engine runs when the aircraft is stationary, or by jet engine 101 during flight, landing or when performing ground maneuvers e.g. at an airport.

Instead of, or in addition to using batteries for storing and releasing electric energy, other means of energy storage may also be provided, such as a mechanical accumulator for accumulating potential energy (e.g. a flywheel), a (hydro-) pneumatic accumulator arranged for accumulating pneumatic energy (e.g. by compressing gas), or a hydraulic accumulator arranged for accumulating hydraulic energy.

During take-off and flight energy accumulator 110 (hereafter referred to as “battery”) of aircraft 200 may discharge when releasing energy to the propellers. Jet engine 101 may therefore be set to a charging mode by the control unit, whereby generator 102 charges battery 102. Part of generator 102 may also be directed towards propellers 103a,b. When in flight, propellers 103a,b may also be set in an electric energy generating (charging) mode, whereby airflow caused by the forward motion of aircraft 200 causes propeller blades of propellers 103a,b to rotate. The propeller electric motors of propellers 103a,b may then function as energy generators and charge battery 110. This way, even with a small capacity generator 102 or the absence or break down of generator 102, battery 110 may still be charged relatively fast. This is especially useful during steady flight, and in particular when decreasing speed, such as before landing. Propellers 103a,b may therefore also be used for regenerative braking, whereby propellers 103a,b provide additional air resistance while being set in charging mode.

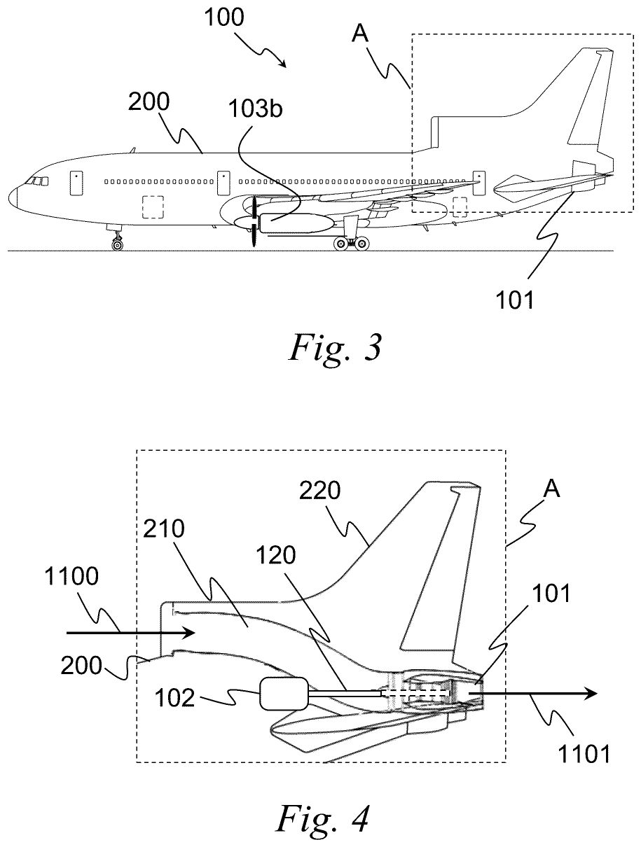

FIG. 2 shows a front view of an embodiment of the invented system 100 incorporated in an example aircraft 200 with one tail mounted jet engine 101 (see also FIGS. 3 and 4) and two wing mounted propellers 103a,b. For clarification purpose, one blade 104 has a reference number, but multiple blades are usually configured in a propeller. The aircraft typically comprises a fuselage with wings 201a,b and tail 202. In a preferred embodiment jet engine 101 is of a tail mounted s-duct type, whereby air is taken in above the fuselage via air intake 210 of aircraft 200 and directed towards jet engine 101 which is mounted in the tail's end at a lower position, hence the word s-duct. This configuration is further explained in FIG. 4.

Propellers 103a,b are preferably mounted under wings 201a,b respectively, but mounting above the wings and other positions are possible as well as stated above.

FIG. 3 shows a side view of the depicted aircraft 200 of FIG. 2 with propeller 103b mounted under wing 201b. Section A of aircraft 200 is enlarged in FIG. 4 to further illustrate the s-duct configuration.

FIG. 4 shows a section A with a see-through detail of an s-duct 210 and jet engine 101. S-duct 210 takes in air via the front section as illustrated by arrow 1100. The air is led through s-duct 210 towards jet engine 101 (comprising a turbine), which is used for burning supplied fuel to provide thrust in direction of arrow 1101. A central shaft 120 of the turbine of jet engine 101 is connected to generator 102 for converting rotational movement of the turbine blades (also referred to as “fan”) of the turbine into electricity as described above. Optionally shaft 120 may be configured such, that it may be coupled and decoupled as needed for generating electricity or not. A control unit may be configured to control coupling and decoupling. A gear mechanism between generator 102 and turbine may be configured such, that rotation of the turbine in one direction leads to rotation of the generator's rotational part in an opposite direction. The counter rotations will reduce or compensate vibrations, and reduces roll of the aircraft.

It should be noted that the above-mentioned embodiments illustrate rather than limit the invention, and that a person skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The term “and/or” includes any and all combinations of one or more of the associated listed items. The article “a” or “an” preceding an element does not exclude the presence of a plurality of such elements. The article “the” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A hybrid aircraft propulsion system comprising:
one or more propellers, arranged as electric propellers comprising rotatable blades and arranged for being powered by a propeller electric motor, whereby the propeller electric motor is arranged for using electric energy from an electric energy supply system for powering the propellor electric motor;
one or more jet engines;
a control unit arranged for controlling the one or more propellers and/or the one or more jet engines;
a jet engine generator associated to a jet engine of the one or more jet engines and arranged for being coupled to the associated jet engine and arranged for converting or transferring energy generated by the jet engine,
an electric jet engine generator arranged for converting energy generated by the jet engine into electric energy, whereby electric energy generated by the electric generator is storing in the electric accumulator, is used for providing electric energy to electric systems of the aircraft and/or used for providing electric energy to the one or more electric propellers,
an energy management system arranged for controlling the acceptance of energy by the energy accumulator, storage of energy in the energy accumulator and release of energy from the energy accumulator,
characterized in that,
a propeller of the one or more propellers is arranged for being selectively using electric energy from the electric energy supply system, using electric energy generated by the jet engine generator directly, or being switched to generating electric energy.

2. The system according to claim 1, characterized in that the system is arranged for storing the generated electric energy in an energy accumulator which is arranged for storing, converting and/or releasing energy as needed.

3. The system according to claim 1, characterized in that the electric energy supply system comprises an on-board energy supply system such as:
the jet engine generator;
an electric accumulator type of the energy accumulator, arranged for accepting, storing and releasing electrical energy as needed, the electric accumulator comprising one or more rechargeable batteries and/or capacitors, such as supercapacitors or ultracapacitors, a DC/AC convertor and a charger,
a fuel cell system arranged for converting chemical energy of a fuel, such as hydrogen, and an oxidizing agent into electricity, said fuel cell system arranged for being refueled form an external fuel storage,
a solar energy system arranged for converting light into electricity.

4. The system according to claim 1, characterized in that a further type of the energy accumulator comprises a mechanical accumulator arranged for accumulating potential energy arranged for accumulating non-electric energy generated by the jet engine.

5. The system according to claim 1, characterized in that a further type of the energy accumulator comprises a pneumatic accumulator arranged for accumulating pneumatic energy or a hydraulic accumulator arranged for accumulating hydraulic energy generated by the jet engine.

6. The system according to claim 3, characterized in that the energy supply system comprises an off-board energy supply system, whereby the aircraft is arranged for exchanging energy with said off-board energy supply system.

7. The system according to claim 1, characterized in that the control unit is arranged for optimizing the propulsion ratio between propellers, jet engine generator, and charging of the energy accumulator appropriate for the actual, desired and/or predicted flight situation of the aircraft.

8. The system according to claim 1, characterized in that the control unit is arranged for functioning fully or partly manually, automatic, with artificial intelligence, or any combination.

9. The system according to claim 1, characterized in that the control unit is arranged for executing actions of the group comprising:
switching the one or more jet engines on or off or controlling throttle;
switching the one or more propellers on or off, controlling throttle or changing the blades' pitch;
coupling or decoupling the jet engine generator to and from an associated jet engine;
coupling or decoupling the propeller motor to and from an associated propeller;
switching the jet engine generator from the energy generation mode to the energy consumption mode and vice versa;
switching the propeller motor from the energy consumption mode to the energy generation mode and vice versa.

10. The system according to claim 1, characterized in that the system comprises an electrical configuration whereby a first propeller of the one or more propellers is electrically connected to a first and/or a second jet engine of the one or more jet engines and to a first and/or second energy accumulator, and a second propeller of the one or more propellers is electrically connected to the first and/or the second jet engine and to the first and/or second energy accumulator, whereby the first propeller is arranged for continued operation when the second propeller or when the first or second energy accumulator fails.

11. An aircraft comprising the hybrid aircraft propulsion system of claim 1, the aircraft having a fuselage comprising:
one or more electric propellers, such as open rotors or ducted fans arranged for providing propulsion of the aircraft, a propellor of the one or more propellors comprising rotatable blades, arranged for being powered by a propeller electric motor, whereby the propeller electric motor is arranged for using electric energy from an electric energy supply system;
one or more jet engines, such as gas turbines, a jet engine of the one or more jet engines comprising an intake duct for providing air for combustion of a combustible fuel, a turbine and a central longitudinal turbine shaft substantially oriented in longitudinal direction of the fuselage;
an electric jet engine generator arranged for converting energy generated by the jet engine into electric energy, and storing the electric energy in an electric accumulator, whereby the stored electric energy is used for providing electric energy to electric systems of the aircraft and/or used for providing electric energy to the one or more electric propellers;
a control unit arranged for controlling the one or more propellers and/or the one or more jet engines;
an energy management system arranged for controlling storage of energy in the energy accumulator and release of energy from the energy accumulator,
characterized in that,
a propeller of the one or more propellers is arranged for being selectively using electric energy from the electric energy supply system, or using electric energy generated by the jet engine generator directly, or being switched to generating electric energy by converting rotational power of the blades as caused by an air stream into electric energy for providing power to the aircraft and/or for storing in the one or more energy accumulators.

12. The aircraft according to claim 11, characterized in that the jet engine generator is arranged for being selectively coupled to or decoupled from the associated jet engine and, when coupled to the associated jet engine, arranged for converting or transferring energy generated by the jet engine.

13. The aircraft according to claim 11, characterized in that the intake duct is of an S-duct type, whereby the rotor of the jet engine generator is positioned in line with the turbine shaft and substantially in line with the longitude of the fuselage.

14. The aircraft according to claim 13, characterized in that the turbine shaft is further arranged as the rotor of the jet engine generator, and arranged for selectively being coupled to and decoupled from the turbine shaft via a gear mechanism, whereby the jet engine generator is rotatable in opposite direction of the turbine.

15. The aircraft according to claim 11, characterized in that the fuselage comprises a left wing and a right wing, whereby a configuration of the one or more propellers and the one or more jet engines comprising any one of the group comprising:
left and a right wing mounted propellers and a tail mounted jet engine,
a tail mounted propeller and left and right wing mounted jet engines;
left and right wing mounted jet engines and left and right wing mounted propellers.

16. The aircraft according to claim 15, characterized in that the configuration is arranged for providing at least a minimum of required combined propulsion power, whereby a redundant jet engine or propeller is provided as a back-up engine or as a sole or additional power source for generating energy for storing in the one or more energy accumulators.

17. The aircraft according to claim 11, characterized in that the jet engine generator comprises an electric motor-generator arranged for being selectively switched from an energy generating mode for generating electric energy, to an electric energy using mode for converting electric energy into mechanical energy for spinning turbine blades of the coupled jet engine in a cold start.

18. The aircraft according to claim 11, characterized in that two or more propellers of the one or more electric propellers are arranged for being selectively electrically or mechanically coupled and decoupled.

19. The aircraft according to claim 11, characterized in that the jet engine generator comprises a rotor rotatable in a stator, and the jet engine is of a turbine type with a rotatable fan, a compressor fan and a turbine, said turbine arranged for rotating a central turbine shaft, whereby the rotor of the jet engine generator is arranged for being selectively coupled to or decoupled from the turbine shaft.

20. A method for hybrid aircraft propulsion system in accordance with claim 1, the method comprising that before a flight of the aircraft, the control unit of the system calculates a minimum necessary charge level and expected potential full electric flying time, when using exclusively battery power, thereby taking into account any one or any combination of variables of the group comprising:
distance to the nearest suitable airport;
state of charge;
state of the batteries;
calculated electrical energy usage during take-off and landing;
weather factors, such as temperature humidity, wind force and wind direction;
takeoff weight of the airplane.
